(19) United States
(12) Patent Application Publication
(10) Pub. No.: US 2018/0204162 A1
(43) Pub. Date: Jul. 19, 2018

(54) ASSIGNING SPACES IN A BUILDING BASED ON COMFORT MODELS

(71) Applicant: Honeywell International Inc., Morris Plains, NJ (US)

(72) Inventors: Petr Endel, Prague (CZ); Ondrej Holub, Prague (CZ); Karel Marik, Revnice (CZ)

(21) Appl. No.: 15/406,540

(22) Filed: Jan. 13, 2017

(51) Int. Cl. G06Q 10/06

(52) U.S. Cl. CPC G06Q 10/06315; G06Q 10/067

(57) ABSTRACT

Methods, devices, and systems for assigning spaces in a building based on comfort models are described herein. One device includes a memory, and a processor configured to execute executable instructions stored in the memory to receive occupant feedback for a number of occupants of a building, receive a number of variables associated with the building, generate a comfort model for each respective occupant of the building using the occupant feedback and the number of variables associated with the building, and assign each respective occupant to a space in the building based on the comfort model generated for each respective occupant and the number of variables associated with the building.

### CROSS REFERENCE TO RELATED APPLICATION

This application is related to U.S. application Ser. No. 14/926,881, filed Oct. 29, 2015, which is incorporated herein by reference in its entirety.

### TECHNICAL FIELD

The present disclosure relates to methods, devices, and systems for assigning spaces in a building based on comfort models.

### BACKGROUND

Buildings can include heating, ventilation, and air conditioning (HVAC) equipment to control the indoor climate of the building. In some examples, HVAC equipment can utilize sensors, such as temperature sensors, and/or thermostats to determine current environmental conditions for different areas and/or zones within the building. In some examples, occupants of the building can utilize the thermostats to change input settings of the HVAC equipment.

In some cases the occupants can have different comfort levels and/or tolerance levels for temperature and other features of a surrounding environment. For example, a first person may be comfortable at a first temperature range and a second person may be comfortable at a second temperature range. In this example, the first person may attempt to change a thermostat to a setting within the first temperature range and the second person may attempt to change the thermostat to a setting within the second temperature range.

The changes to the thermostat from the occupants can result in conflicts between the occupants, increased temperature fluctuation, and/or an under/over-utilization of HVAC resources. These conflicts and/or temperature fluctuations can result in less productivity from the occupants and higher HVAC costs.

### BRIEF DESCRIPTION OF THE DRAWINGS

FIG. 1 is a graphical representation of comfort models for assigning spaces in a building, in accordance with one or more embodiments of the present disclosure.

FIG. 2 is a graphical representation of a comfort model for assigning spaces in a building, in accordance with one or more embodiments of the present disclosure.

FIG. 3 is a schematic block diagram of a building space layout for assigning spaces in a building based on comfort models, in accordance with one or more embodiments of the present disclosure.

FIG. 4 is a flow chart of a method for assigning spaces in a building based on comfort models, in accordance with one or more embodiments of the present disclosure.

FIG. 5 is a flow chart of a method for assigning spaces in a building based on comfort models, in accordance with one or more embodiments of the present disclosure.

FIG. 6 is a graphical representation of a comfort graph for assigning spaces in a building based on comfort models, in accordance with one or more embodiments of the present disclosure.

FIG. 7 is a schematic block diagram of a system for assigning spaces in a building based on comfort models, in accordance with one or more embodiments of the present disclosure.

### DETAILED DESCRIPTION

Methods, devices, and systems for assigning spaces in a building based on comfort models are described herein. For example, one or more embodiments include a memory, and a processor configured to execute executable instructions stored in the memory to receive occupant feedback for a number of occupants of a building, receive a number of variables associated with the building, generate a comfort model for each respective occupant of the building using the occupant feedback and the number of variables associated with the building, and assign each respective occupant to a space in the building based on the comfort model generated for each respective occupant and the number of variables associated with the building.

Assigning building spaces based on comfort models, in accordance with the present disclosure, can incorporate feedback of occupants of the building to assign seating arrangements for the occupants such that conflicts between occupants over environmental conditions, such as temperature settings, can be reduced. Further, spaces of a building, such as meeting rooms, can be selected based on occupant feedback to increase comfort levels in that space, as well as to save energy by decreasing setpoint changes in the space. Assigning seating and spaces in this manner can increase occupant comfort and, in turn, increase occupant productivity.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit or digits correspond to the drawing figure number and the remaining digits identify an element or component in the drawing. Similar elements or components between different figures may be identified by the use of similar digits.

As used herein, “a” or “a number of” something can refer to one or more such things. For example, “a number of variables” can refer to one or more variables.

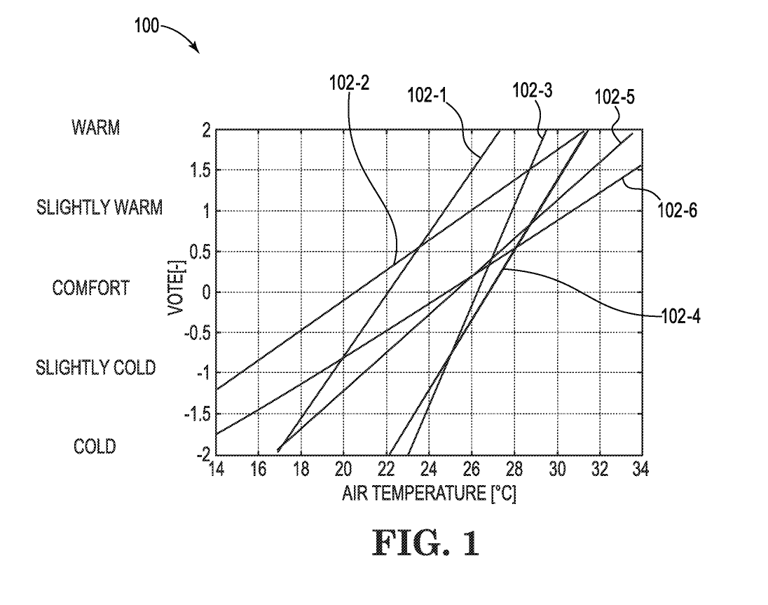

FIG. 1 is a graphical representation 100 of comfort models for assigning spaces in a building, in accordance with one or more embodiments of the present disclosure. As shown in FIG. 1, the graphical representation 100 can include occupant comfort models 102-1, 102-2, 102-3, 102-4, 102-5, 102-6 (referred to collectively as occupant comfort models 102).

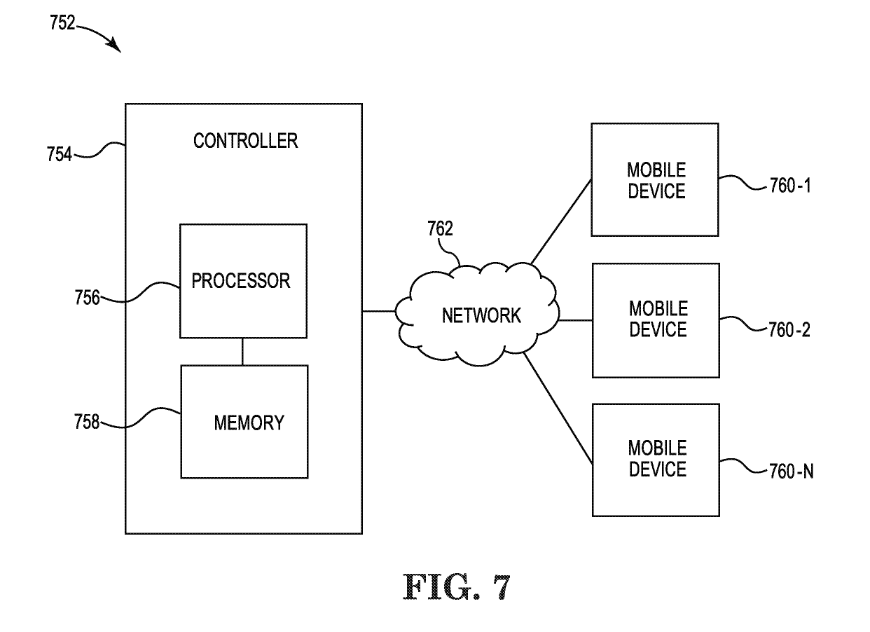

A controller (e.g., controller 754, as will be described in connection with FIG. 7) can receive occupant feedback for a number of occupants of a building. As used herein, occupant feedback can be an indication of comfort of an occupant of a building and/or space within the building. For example, an occupant of a space of a building can indicate (e.g., by a mobile device, as will be further described herein) whether that occupant is comfortable with a number of internal variables (e.g., temperature, lighting, humidity, etc.) of the space, as will be further described herein. Feedback (e.g., a comfort indication or comfort request) of an occupant can be a desire of the occupant to increase general comfort.

Occupant feedback can be received (e.g., by a controller) from a mobile device (e.g., mobile devices 760, described in connection with FIG. 7) corresponding to an occupant of the building. For example, a building may include a number of occupants, each having a mobile device. The number of occupants can each indicate, via their mobile devices, information regarding their general comfort in the building space. Those respective mobile devices may then transmit those respective indications to the controller.

As used herein, a mobile device can include devices that are (or can be) carried and/or worn by the user. A mobile device can include a phone (e.g., a smart phone), a tablet, a personal digital assistant (PDA), smart glasses, and/or a wrist-worn device (e.g., a smart watch), among other types of mobile devices.

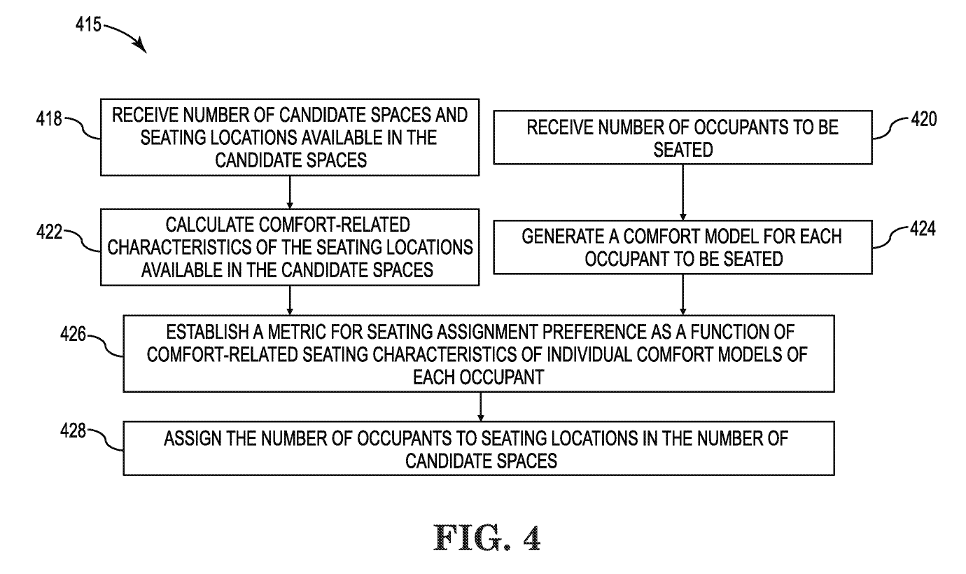

The controller can receive, from the number of mobile devices corresponding to each occupant of the building, the occupant feedback via a network relationship. For example, the occupant feedback can be transmitted to the controller from the number of mobile devices via a wired or wireless network (e.g., network 423, described in connection with FIG. 4).

The wired or wireless network can be a network relationship that connects the number of mobile devices to the controller. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, and/or the Internet, among other types of network relationships.

The occupant feedback can indicate environmental feedback for the space. For example, the occupant feedback can indicate a temperature of the building and/or space of the building is too hot. That is, the occupant desires a decrease in temperature of the space and can indicate as such by indicating that occupant preference. In further examples, the occupant feedback can indicate the temperature of the building is comfortable, or is too cold.

Although occupant feedback is described as including too hot and/or too cold feedback, embodiments of the present disclosure are not so limited. For example, as shown in FIG. 1, feedback can include being warm, slightly warm, comfort, slightly cold, and/or cold.

Although the occupant feedback is described as including temperature, embodiments of the present disclosure are not so limited. For example, occupant feedback can include lighting feedback, relative humidity feedback, air quality feedback, and/or other environmental feedback.

The controller can also receive a number of variables associated with the building. The number of variables associated with the building can include internal variables, external variables, and/or cost variables, among other types of variables associated with the building.

The internal variables associated with the building can include internal variables associated with the spaces of the building, such as an internal temperature of the space, an internal relative humidity level of the space, an internal air quality level of the space, internal lighting, fan speeds, levels of CO₂ in the air of the space, levels of O₂ in the air of the space, frequency and/or magnitude of air exchanges to the space, fresh air balance of the space, HVAC damper positions, positions of window blinds, occupancy including the number of occupants, time of day, and/or the schedule of occupancy (e.g., from reservation systems), among other internal variables associated with the space. The internal variables associated with the space can include current readings, recent trends in readings, and/or historical trends in readings.

The controller can receive the internal variables from a number of internal sensors via a wired or wireless network. Internal sensors can include temperature sensors (e.g., thermometers, thermocouples, thermistors, etc.), humidity sensors (e.g., humistors, humidistats, etc.), air quality sensors (e.g., carbon monoxide sensors, carbon dioxide sensors, etc.), lighting sensors (e.g., photoresistors, photodiodes, etc.), and/or occupancy sensors, among other types of internal sensors.

The external variables associated with the building can include an external temperature, an external humidity level, an external lighting level, wind speed, wind direction, angle and direction of sunlight, precipitation, and/or outdoor air quality, among other external readings. The external variables associated with the building can include current readings, recent trends in readings, historical trends in readings, and/or weather forecasts, etc.

The controller can receive the external variables from a number of external sensors via a wired or wireless network. External sensors can include temperature sensors (e.g., thermometers, thermocouples, thermistors, etc.), humidity sensors (e.g., humistors, humidistats, etc.), and/or lighting sensors (e.g., photoresistors, photodiodes, etc.), among other types of external sensors.

The cost variables associated with the building can include costs to heat and/or light spaces of the building. For example, the controller can receive an amount of energy being used by the HVAC and/or lighting system associated with settings of the space. Settings of the space can include temperature, relative humidity, CO₂, O₂, damper position, air intake, chilled water temperature, hot water temperature and/or reheater set points, among other settings. Additionally, the controller can receive cost information from a utility, such as a monetary cost per unit of energy. As used herein, a utility refers to an organization that provides services such as electricity, natural gas, water, etc.

For example, the controller may receive a cost of $0.15 per kilowatt hour (kWh) of energy used from the utility. The controller can determine an amount of money needed to heat and/or light a space based on (e.g., by multiplying) the cost per unit of energy from the utility (e.g., $0.15/kWh) and an amount of energy used to heat and/or light the space (e.g., 100 kWh).

The controller can generate occupant comfort models 102 illustrated in graphical representation 100 for each respective occupant of the building using the occupant feedback and the number of variables associated with the building. The x-axis of graphical representation 100 can represent an air temperature of a space of a building, and the y-axis of graphical representation 100 can represent occupant feedback.

An occupant can indicate, via that occupant's respective mobile device, whether they are comfortable or uncomfortable in the building space. Comfort of an occupant can be based on environmental conditions of the building space. In some examples, an occupant can indicate whether they are comfortable, feel too hot, or feel too cold. That occupant feedback can be correlated with variables associated with the building, for example an air temperature of the space of the building, or other variables.

The controller can generate occupant comfort models 102 for each respective occupant by plotting the occupant feedback for each respective occupant and the number of variables associated with the building. For example, the controller can plot an occupant's feedback of “comfortable” with an air temperature around 20° C. Further, the occupant may indicate that at an air temperature of around 19° C., that occupant feels “slightly cold”, and at an air temperature of around 25° C., that occupant feels “slightly warm”. Using these data points, the controller can generate an occupant comfort model 102-1 for that occupant.

Although occupant comfort models are described as being generated using occupant feedback and temperature, embodiments of the present disclosure are not so limited. For example, occupant comfort models may be generated as multi-dimensional models using occupant feedback and other environmental conditions, such as relative humidity, lighting, air quality, etc.

The controller can generate occupant comfort models 102 for all occupants. For instance, the controller can generate occupant comfort models 102-1, 102-2, 102-3, 102-4, 102-5, 102-6 that correspond to six different occupants, although embodiments of the present disclosure are not limited to six occupants. For instance, the controller can generate occupant comfort models for less than six, or more than six occupants, if less or more than six occupants are in the space.

In some embodiments, occupant comfort models 102 can be saved in a database for use at a later time. Generating the occupant comfort models 102 can include retrieving a comfort model for each of a plurality of occupants within an area of the building. For example, the occupant comfort models 102 for each of a plurality of occupants can be generated by the controller. In this example, the controller can store the occupant comfort models 102 in a database to be retrieved and utilized when occupants are identified within the area.

The slope of each occupant comfort model 102 can correspond to that occupant's sensitivity to changes in the space. For example, occupant comfort model 102-3 has a slope that is greater than the slope of occupant comfort model 102-1, which may indicate that the occupant corresponding to occupant comfort model 102-3 has a greater sensitivity to, for example, temperature changes in the space than the occupant corresponding to occupant comfort model 102-1.

Although shown in FIG. 1 as including occupant feedback with respect to air temperature, embodiments of the present disclosure are not so limited. For example, the controller can generate occupant comfort models for other variables of the building, including relative humidity, lighting, air quality, etc.

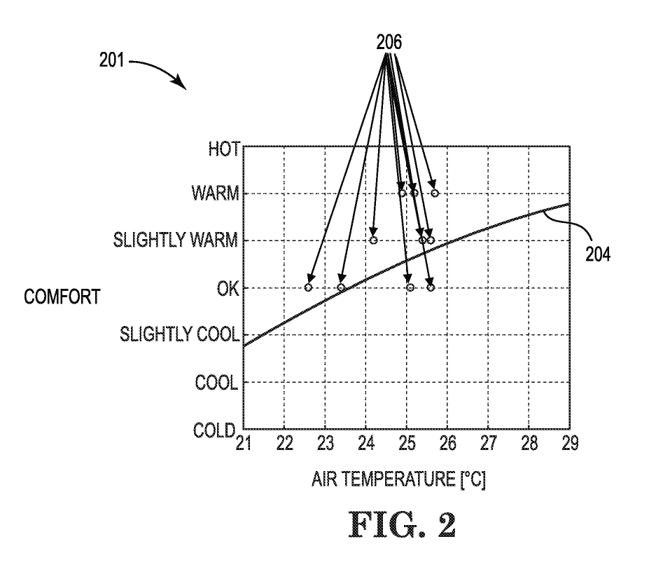

FIG. 2 is a graphical representation 201 of a comfort model for assigning spaces in a building, in accordance with one or more embodiments of the present disclosure. As shown in FIG. 2, the graphical representation 201 can include an occupant comfort model 204 and occupant feedback 206.

As previously described in connection with FIG. 1, a controller can receive occupant feedback 206. Occupant feedback 206 can indicate comfort of an occupant of a building and/or a space within the building. As shown in FIG. 2, occupant feedback 206 can include a number of indications of comfort of an individual occupant at various temperatures of a building space. For instance, an occupant can indicate that they feel comfortable (e.g., “OK”) at an air temperature of near 22.5° C., comfortable at an air temperature near 23.5° C., slightly warm at an air temperature near 24° C., warm at an air temperature of 25° C., etc.

The occupant can submit a number of indications of comfort as occupant feedback 206 over a period of time. The controller can, in response to receiving occupant feedback 206, generate an occupant comfort model 204 for the occupant. Occupant comfort model 204 can be similar to an occupant comfort model 102, previously described in connection with FIG. 1.

Occupant comfort model 204 can be generated by plotting occupant feedback 206 for the occupant of the space. Occupant feedback 206 can be plotted using the occupant feedback and air temperature. Occupant comfort model 204 can be generated by fitting a curve to the plotted occupant feedback 206.

In some embodiments, occupant comfort model 204 can be generated using prior knowledge in combination with occupant feedback 206. Prior knowledge can include general comfort models, such as general comfort models known from scientific experimentation and/or published literature. Additionally or alternatively, prior knowledge can include a predicted mean vote. Occupant comfort model 204 can be generated using a combination of occupant feedback 206 and prior knowledge.

As shown in FIG. 2, occupant comfort model 204 can be non-linear. For instance, occupant comfort model 204 may have a moderate slope for higher temperatures and a steeper slope for lower temperatures, indicating the occupant is less sensitive to higher temperatures and more sensitive to lower temperatures.

Although shown in FIG. 2 as including occupant feedback 206 with respect to air temperature, embodiments of the present disclosure are not so limited. For example, the controller can generate occupant comfort model 206 for one or more other variables of the building, including relative humidity, lighting, air quality, etc.

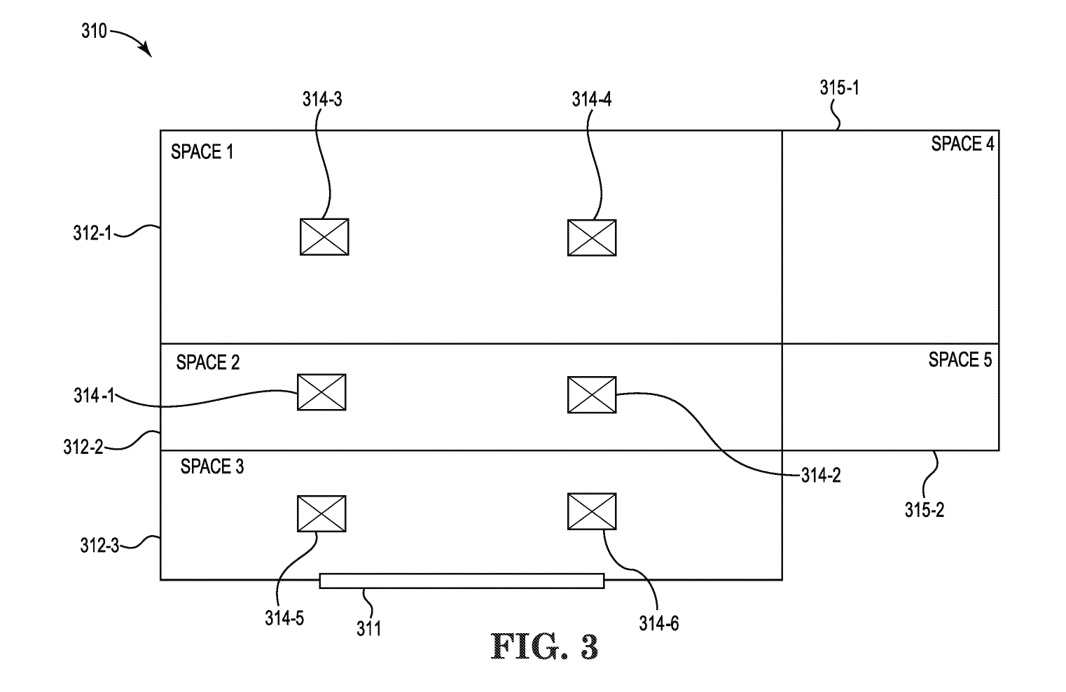

FIG. 3 is a schematic block diagram of a building space layout 310 for assigning spaces in a building based on comfort models, in accordance with one or more embodiments of the present disclosure. As shown in FIG. 3, the building space layout 310 can include spaces 312-1, 312-2, 312-3 (referred to collectively as spaces 312) and window 311. Each of the spaces 312 can include seating locations 314-1, 314-2, 314-3, 314-4, 314-5, and 314-6 (referred to collectively as seating locations 314). As shown in FIG. 3, space 312-1 can include seating locations 314-3 and 314-4, space 312-2 can include seating locations 314-1 and 314-2, and space 312-3 can include seating locations 314-5 and 314-6.

A controller (e.g., controller 754 described in connection with FIG. 7) can assign each respective occupant of the building to spaces 312 in the building based on the occupant comfort model generated for each respective occupant and the number of variables associated with the building. For instance, each respective occupant can be assigned to a spaces 312 based on each occupant's comfort model and the internal variables of the building.

Seating locations 314 in spaces 312 can be described based on the number of internal variables of the building. The number of internal variables of the building can be logged during relevant parts of the day. For instance, the number of internal variables can be logged based on a general occupancy schedule of spaces 312. The general occupancy schedule of spaces 312 can be received by the controller from a building automation system.

As previously described in connection with FIG. 1, the internal variables can include variables associated with spaces 312 and/or seating locations 314 of the building. For example, the internal variables can include an internal temperature of the space, an internal relative humidity level of the space, an internal air quality level of the space, internal lighting, fan speeds, levels of CO₂ in the air of the space, levels of O₂ in the air of the space, frequency and/or magnitude of air exchanges to the space, fresh air balance of the space, HVAC damper positions, positions of window blinds, occupancy including the number of occupants, time of day, and/or the schedule of occupancy (e.g., from reservation systems), among other internal variables associated with the space.

In some embodiments, the internal variables can be represented by a full probability distribution of the number of internal variables of the building.

In some embodiments, the internal variables can be represented by a mean value, or a range of most likely values of internal variables of the building. In some examples, a range of the most likely values of variables (e.g., between the 10^{th} and 90^{th} percentile) of the entire range of logged internal variables can be representative of the number of internal variables of the building.

Although the number of internal variables are described as being per zone, embodiments of the present disclosure are not so limited. For example, the number of internal variables can be per seating location.

In some examples, space 312-1 may be a space that is farthest from window 311, while spaces 312-2 and 312-3 are closer to window 311. As a result, space 312-3 may be more prone to temperature changes as a result of sunlight entering the building space layout 310 through window 311, whereas space 312-2 and 312-1 may be less affected.

As previously described in connection with FIG. 1, the occupants corresponding to occupant comfort models 102-3 and 102-4 can be the most sensitive to temperature changes. Those occupants can therefore be assigned to (e.g., seated at) seating locations 314-3 and 314-4 of space 312-1, since space 312-1 is the least prone to temperature changes as a result of window 311 near space 312-3. Correspondingly, the occupants corresponding occupant comfort models 102-5 and 102-6 can be the least sensitive to temperature changes, and those occupants can be seated at seating locations 314-5 and 314-6 of space 312-3, since space 312-3 is the most prone to temperature changes as a result of window 311 near space 312-3. Accordingly, the occupants corresponding to occupant comfort models 102-1 and 102-2 may not be as sensitive to temperature changes as occupants corresponding to occupant comfort models 102-3, 102-4, 102-5, and 102-6, and therefore may be seated at seating locations 314-1 and 314-2 of space 312-2.

The controller can also assign each respective occupant to a space based on HVAC costs of conditioning the spaces to a specified level of comfort. For instance, it can cost more in HVAC operational costs to condition a space to a comfortable level for an occupant that is more sensitive to temperature changes. The controller can therefore assign those more sensitive occupants to spaces 312 that are less prone to temperature changes. For instance, space 312-1 may be less prone to temperature changes as a result of being located farther away from window 311 located near space 312-3. The controller may utilize cost information to determine it costs less to condition space 312-1 because the temperature does not vary as much as spaces 312-2 and/or 312-3. Therefore, occupants corresponding to occupant comfort models 102-3 and 102-4 can be seated at seating locations 314-3 and 314-4 of space 312-1.

In some embodiments, the controller can detect a comfort-related anomaly. An anomaly can include a systematic offset in occupant feedback indications. The offset can be for a space within a building and/or a seating location within a space. The controller can compensate for the anomaly.

The controller can assign each respective occupant to a seating location within a space based on a cumulative time the particular occupant will experience comfort conditions at a particular seat. For example, based on the time of day and the internal variables associated with the building, the controller can determine that an occupant will experience comfort for the most amount of time at seating location 314-3 in space 312-1.

Although the cumulative time is described as being for an individual seating location, embodiments of the present disclosure are not so limited. For example, the cumulative time can apply to spaces 312. The cumulative time for a space can be a sum of the estimates for experiencing comfort conditions at a particular seat over all seats in the space 312.

As previously described in connection with FIG. 1, the controller can receive a meeting request that includes the attendees of the meeting associated with the meeting request and the time of day of the meeting. For example, the controller may receive a meeting request for the afternoon that includes four occupants. In response to the meeting request, the controller can assign a space in the building using the comfort models and the number of variables associated with the building.

In some embodiments, the controller can receive a meeting request, including a request for a meeting space within the building. The meeting request can include the attendees of the meeting associated with the meeting request and the time of day for the meeting. For example, an occupant may need to schedule a meeting with other occupants (e.g., colleagues), and may request a meeting. The occupant may request the meeting via their mobile device, and/or any other computing device. As used herein, a computing device can be, for example, a laptop computer, a desktop computer, or a mobile device (e.g., a smart phone, tablet, personal digital assistant, smart glasses, a wrist-worn device, etc.), among other types of computing devices.

The meeting request may include information including an identity of each occupant that is attending the meeting. For example, the controller may receive a meeting request that includes the occupants attending the meeting. The controller can assign a space in the building in response to the meeting request using occupant comfort models (e.g., occupant comfort models 102-1, 102-3, and 102-6, previously described in connection with FIG. 1) and the number of variables associated with the building.

In some examples, based on the attendees of the meeting, the controller can aggregate the occupant comfort models corresponding to each respective attendee of the meeting into an aggregated comfort model, which may be used for assigning the space in the building in response to the meeting request.

The controller can assign a space in the building in response to the meeting request based on the comfort level of the aggregated comfort model. In some examples, the meeting attendees may include occupants corresponding to occupant comfort models 102-3, 102-4, 102-5, and 102-6. Since the occupants corresponding to occupant comfort models 102-3, 102-4, 102-5, and 102-6 may prefer on average a warmer temperature, the controller may assign space 315-1, which may have a zone temperature that is close to the preferred temperature of occupants corresponding to occupant comfort models 102-3, 102-4, 102-5, and 102-6.

In some embodiments, the controller can assign a weight to the occupant feedback and/or comfort model based on a role of each respective occupant. As used herein, a weighted occupant preference can refer to occupant feedback indication or occupant comfort model multiplied by a factor reflecting the feedback's importance. For example, the feedback of an occupant such as a supervisor can be considered with more weight than the feedback of an occupant who holds a lower position than the supervisor. As another example, a feedback of an occupant who is a customer can be considered with more weight than the feedback of an occupant who is an employee.

The controller can assign a space in the building in response to the meeting request based on an occupant capacity of the space in the building. The controller can utilize a weighted difference between the number of attendees associated with the meeting request and meeting room occupant capacity. For example, a morning meeting request may be received by the controller including five occupants that are more sensitive to temperature changes. Although space 315-2 may be more suitable for occupants that are more sensitive to temperature changes for a morning meeting, the occupant capacity of space 315-2 may only be four occupants. The controller can therefore assign space 315-1 in response to the meeting request, as the occupancy capacity space 315-1 may be ten occupants.

The controller can assign a space in response to the meeting request based on HVAC costs associated with the HVAC system reaching and/or maintaining comfortable environmental conditions for a space (e.g., temperature, humidity, lighting, etc.) based on each occupant comfort model and/or an aggregated comfort model. For instance, it can cost more in HVAC operational costs to condition a space to a comfortable level for occupants that prefer low zone temperatures. The controller can therefore assign the occupants to a space that costs less in HVAC costs to condition to the preferred low zone temperature.

The HVAC costs associated with the HVAC system reaching and/or maintaining comfortable environmental conditions for a space can be based on a time of day associated with the meeting request. For instance, it can cost more in HVAC operational costs to condition a space to a comfortable level for different times of the day. For example, space 315-1 may experience more sunlight during morning hours and space 315-2 may experience more sunlight during afternoon hours. As such, space 315-1 may experience a sun irradiation heat gain in the morning and require higher HVAC operational costs to condition space 315-1 in the morning. Space 315-2 may experience more temperature fluctuations in the afternoon and require higher HVAC operational costs to condition space 315-2 in the afternoon.

The controller can therefore assign space 315-1 to occupants that are less sensitive to temperature changes for a morning meeting in response to a meeting request. Correspondingly, the controller can assign space 315-2 to occupants that are more sensitive to temperature changes for a morning meeting in response to a meeting request. Additionally, the controller can assign space 315-1 to occupants that are more sensitive to temperature changes for an afternoon meeting in response to a meeting request. Further, the controller can assign space 315-2 to occupants that are less sensitive to temperature changes for an afternoon meeting in response to a meeting request.

As an additional example, a meeting request may be received by the controller including four occupants. Based on current environmental conditions in space 315-2, it may be infeasible to condition space 315-2 to a comfortable temperature based on the occupant comfort models of the attendees of the meeting (e.g., it would take too long and/or be too expensive to cool down space 315-2 to a comfortable temperature), and the controller may therefore assign space 315-1 in response to the meeting request.

Although the controller is described as assigning a space in the building in response to a meeting request based on the occupant comfort models corresponding to each respective attendee of the meeting, an aggregated comfort model, occupant capacity of the building space (e.g., the meeting room), HVAC costs associated with a comfortable condition from each occupant comfort model and/or an aggregated comfort model, and/or time of day of the meeting individually, embodiments of the present disclosure are not so limited. For example, the controller may assign the space in the building in response to the meeting request based upon a combination of the above listed factors.

The controller can assign a space in the building based on weighted occupant feedback. As previously described in connection with FIG. 1, an occupant may have an occupant feedback that is weighted more heavily than another occupant and consequently may be treated with more importance by the controller. For example, a customer who is sensitive to temperature changes may visit the building layout 310 and submit a meeting request. The controller may assign the customer to space 315-1 for a morning meeting over another occupant who is sensitive to temperature changes who submitted a meeting request, as the customer's occupant feedback is more heavily weighted than the other occupant's occupant feedback.

Although building layout 310 is shown in FIG. 3 as including two spaces 315-1 and 315-2 for use as meeting rooms, embodiments of the present disclosure are not so limited. For example, the building layout 310 may include less than two spaces or more than two spaces for use as meeting rooms.

In some examples, the controller can generate, in response to receiving the meeting request, a list of candidate spaces from a total number of spaces of the building. The list of candidate spaces can be based on occupant comfort models associated with each respective attendee of a meeting associated with the meeting request and/or an aggregated comfort model, and the number of variables associated with the building. For example, although not shown in FIG. 3, a building may include more than two spaces (e.g., eight spaces) for meeting rooms. The controller can generate a list of three spaces of the eight spaces that may be appropriate for a meeting associated with the meeting request based on occupant comfort models associated with each respective attendee of the meeting and the number of variables associated with the building.

In some examples, the controller can select and assign the space from the list of spaces based on HVAC costs associated with a comfortable condition (e.g., temperature, etc.) based on each occupant comfort model and/or an aggregated comfort model. That is, the controller can select and assign the space based on a comfortable condition derived from occupant comfort models corresponding to each respective attendee of the meeting associated with the meeting request.

In some examples, the controller can select and assign the space from the list of spaces based on a time of day of the meeting associated with the meeting request. Continuing with the above example, the controller may determine that a first of the three spaces may be appropriate for the meeting based on the comfort models corresponding to each respective attendee of the meeting. Further, the controller may determine the first of the three spaces is most appropriate based on the meeting occurring in the afternoon, whereas the controller may have determined the second of the three spaces would have been more appropriate had the meeting occurred in the morning.

Assigning spaces based on occupant comfort models can allow for optimal assignment of spaces with respect to occupants' comfort and/or HVAC operational costs. For example, occupants with colder feedback indications can be assigned seating in spaces which are colder, while occupants with warmer feedback indications can be assigned seating in spaces which are warmer. Providing occupants with comfortable spaces can lead to higher productivity while reducing costs associated with HVAC operation for the building.

FIG. 4 is a flow chart of a method for assigning spaces in a building based on comfort models, in accordance with one or more embodiments of the present disclosure. Method 416 can be performed, for example, by a controller (e.g., controller 754, described in connection with FIG. 7).

At 418, the method 416 can include receiving, by the controller, a number of candidate spaces and seating locations available in the candidate spaces. Candidate spaces can include different spaces available for assignment, and the seating locations available can include seats available for assignment in different candidate spaces. As previously described in connection with FIG. 3, candidate spaces can be analogous to spaces 312-1, 312-2, 312-3, and seats available in candidate spaces can be analogous to seating locations 314-1, 314-2, 314-3, 314-4, 314-5, 314-6. For example, the controller can receive two candidate spaces, where each candidate space includes ten seating locations available.

At 420, the method 416 can include receiving, by the controller, a number of occupants to be seated. For example, there may be five occupants that need to be seated in seating locations in a candidate space.

The number of candidate spaces, seating locations available in the candidate spaces, and the number of occupants to be seated can be variables associated with the building.

At 422, the method 416 can include calculating, by the controller, comfort-related characteristics of the seating locations available in the candidate spaces. For example, the controller can determine comfort-related characteristics of each seating location available in each candidate space using the number of internal variables associated with the building. For example, the controller can determine an internal temperature, humidity level, air quality level, lighting level, etc. of each seating location.

At 424, the method 416 can include generating, by the controller, a comfort model for each occupant to be seated. For example, the controller can generate a comfort model for each occupant using occupant feedback from the occupant and/or prior knowledge of general comfort models.

At 426, the method 416 can include establishing, by the controller, a metric for seating assignment preferences as a function of comfort-related seating characteristics for individual comfort models of each occupant. For example, the controller can determine a metric to seat occupants based on each occupant's comfort model. The metric can include occupant comfort, HVAC operational costs, etc.

At 428, the method 416 can include assigning, by the controller, the number of occupants to seating locations in the number of candidate spaces. Assigning the number of occupants to seating locations can include maximizing the metric to seat occupants based on each occupant's comfort model.

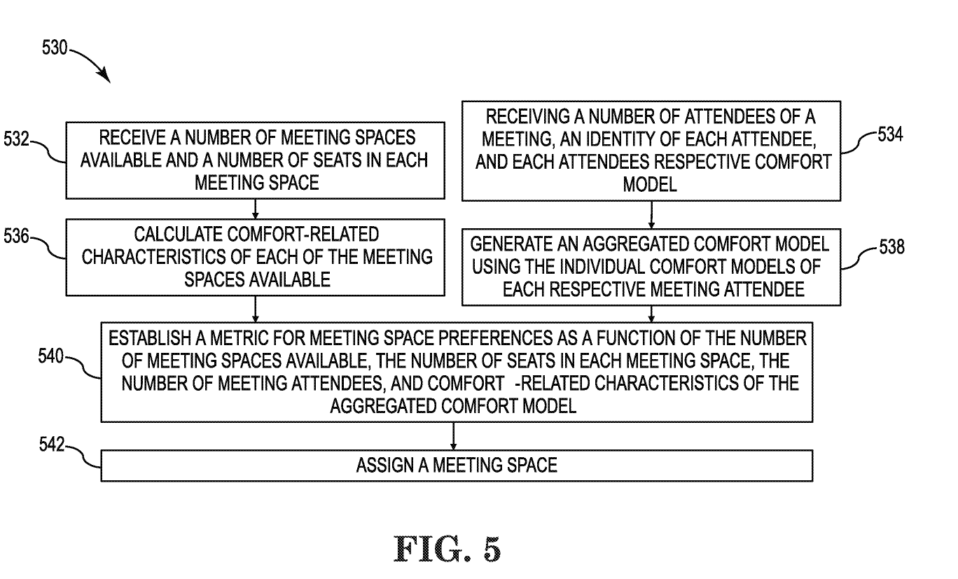

FIG. 5 is a flow chart of a method for assigning spaces in a building based on comfort models, in accordance with one or more embodiments of the present disclosure. Method 530 can be performed, for example, by a controller (e.g., controller 754, described in connection with FIG. 7).

At 532, the method 530 can include receiving, by the controller, a number of meeting spaces available and a number of seats in each meeting space. The number of meeting spaces can include seats available for use in different meeting spaces. As previously described in connection with FIG. 3, meeting spaces can be analogous to spaces 315-1 and 315-2. For example, the controller can receive two meeting spaces, where each meeting space includes five seats.

At 534, the method 530 can include receiving, by the controller, a number of attendees of a meeting, the identity of each attendee, and each attendees respective individual comfort models. For example, there may be four attendees of a meeting, and each attendee may include identity information indicating who each attendee is, as well as individual comfort models for each attendee.

At 536, the method 530 can include calculating, by the controller, comfort-related characteristics of each of the meeting spaces available. For example, the controller can determine comfort-related characteristics of each meeting space available using the number of internal variables associated with the building. For example, the controller can determine an internal temperature, humidity level, air quality level, lighting level, etc. of each meeting space.

At 538, the method 530 can include generating, by the controller, an aggregated comfort model using the individual comfort models of each respective meeting attendee. The controller can aggregate the individual occupant comfort models using a k-means clustering algorithm, although embodiments of the present disclosure are not limited to a k-means clustering algorithm. As used herein, k-means clustering refers to a method of quantization that includes partitioning N observations into k clusters (e.g., groups). For instance, the controller can partition N number of occupant comfort models into k groups.

Although the controller is described as aggregating occupant comfort models by a k-means clustering algorithm, embodiments of the present disclosure are not so limited. For example, the controller can aggregate occupant comfort models using stochastic optimization and/or an exhaustive search (e.g., a brute force approach).

The aggregated comfort model can include an aggregated comfort temperature. The aggregated comfort temperature can represent the average temperature of respective meeting attendees at which each attendee is comfortable.

At 540, the method 530 can include establishing, by the controller, a metric for meeting space preferences as a function of the number of meeting spaces available, the number of seats in each meeting space, the number of meeting attendees, and comfort-related characteristics of the aggregated comfort model. The metric can include occupant comfort, HVAC operational costs, etc.

At 542, the method 530 can include assigning, by the controller, a meeting space. Assigning the meeting space can include maximizing the metric to assign a meeting space based on the aggregated comfort model.

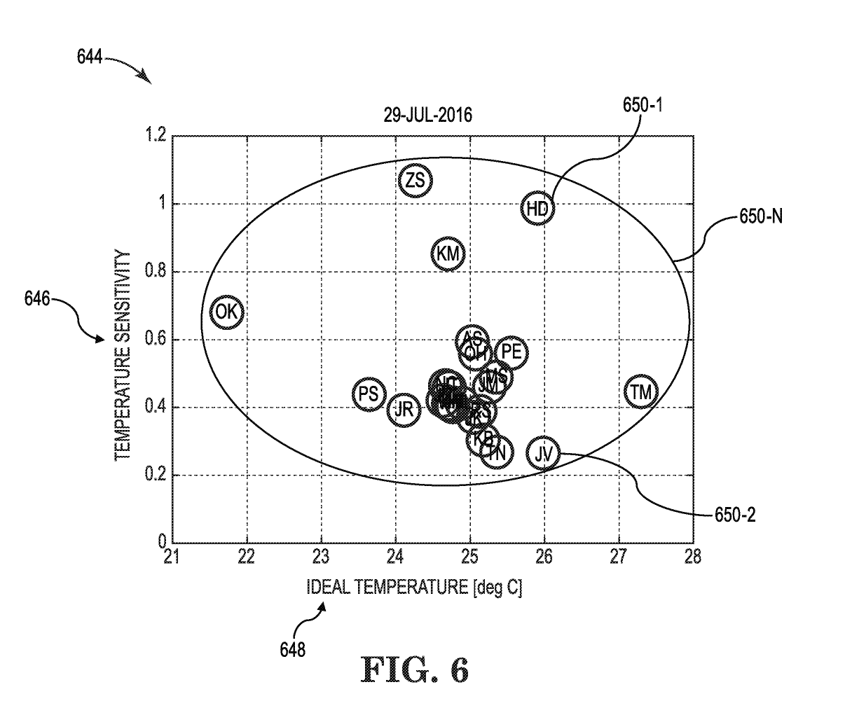

FIG. 6 is a comfort graph 644 for assigning spaces in a building based on comfort models, in accordance with one or more embodiments of the present disclosure. As shown in FIG. 6, the comfort graph 644 can include environmental sensitivity 646, ideal comfort level 648, and data points 650-1, 650-2, 650-N.

A controller (e.g., controller 754, as will be described in connection with FIG. 7) can generate comfort graph 644 using occupant feedback (e.g., previously described in connection with FIG. 1) and a number of variables associated with a building (e.g., previously described in connection with FIG. 1). Comfort graph 644 can include data points 650-N for each of the number of occupants of the building. Each of the data points 650-N can be based on an ideal comfort level 648 and an environmental sensitivity 646 of each respective occupant.

Comfort graph 644 can include an X-axis. As shown in FIG. 6, the X-axis can show an ideal comfort level 648. Ideal comfort level 648 can represent an ideal level of comfort for each individual occupant. For example, as shown in FIG. 6, the ideal comfort level 648 can be represented by an ideal temperature, where a building occupant represented by data point 650-2 can have an ideal comfort temperature of 26° C. Although ideal comfort level 648 is described as being represented by an ideal temperature, embodiments of the present disclosure are not so limited. For instance, ideal comfort level 648 can be represented by any other building variable (e.g., ideal comfort relative humidity, ideal comfort lighting level, ideal comfort air quality, etc.)

Comfort graph 644 can include a Y-axis. As shown in FIG. 6, the Y-axis can show an environmental sensitivity 646. Environmental sensitivity 646 can represent a sensitivity for each individual occupant to changes in environmental conditions in a building space. For example, as shown in FIG. 6, the building occupant represented by data point 650-1 (e.g., “HD”) can have a higher sensitivity (e.g., be more sensitive) to temperature changes in a building space than the building occupant represented by data point 650-2 (e.g., “JV”).

Comfort graph 644 can provide a visualization tool for occupants such as building and/or facility managers to easily monitor occupant preferences of building occupants. For example, a facility manager can easily group building occupants based on comfort levels and environmental sensitivity, and/or determine building occupants with outlier preferences and/or sensitivities.

FIG. 7 is a schematic block diagram of a system 752 for assigning spaces in a building based on comfort models, in accordance with one or more embodiments of the present disclosure. System 752 can include a controller 754 and mobile devices 760-1, 760-2, 760-N (referred to collectively as mobile devices 760). Controller 754 can include a memory 758 and a processor 756 configured for assigning spaces in a building based on comfort models, in accordance with the present disclosure.

The memory 758 can be any type of storage medium that can be accessed by the processor 756 to perform various examples of the present disclosure. For example, the memory 758 can be a non-transitory computer readable medium having computer readable instructions (e.g., computer program instructions) stored thereon that are executable by the processor 756 to receive, via network 762, occupant feedback for a number of occupants of a number of spaces of a building from a number of mobile devices 760, receive from a number of sensors, a number of variables associated with the number of spaces, generate a comfort model for each respective occupant of the building using the weighted occupant feedback and the number of variables associated with the number of spaces, and assign each respective occupant to a different space in the building based on the comfort model for each occupant and the number of variables associated with the number of spaces. Further, the processor 756 can execute the executable instructions stored in memory 758 to receive a meeting request from a mobile device of the number of mobile devices 760, and assign a space in the building in response to the meeting request using comfort models associated with each respective attendee of a meeting associated with the meeting request and the number of variables associated with the building.

The memory 758 can be volatile or nonvolatile memory. The memory 758 can also be removable (e.g., portable) memory, or non-removable (e.g., internal) memory. For example, the memory 758 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 758 is illustrated as being located within controller 754, embodiments of the present disclosure are not so limited. For example, memory 758 can also be located internal to another computing resource (e.g., enabling computer readable instructions to be downloaded over the Internet or another wired or wireless connection).

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor. It is presumed that logic similarly executes instructions for purposes of the embodiments of the present disclosure.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A controller for assigning spaces in a building, comprising:
a memory; and
a processor configured to execute executable instructions stored in the memory to:
receive occupant feedback for a number of occupants of a building;
receive a number of variables associated with the building;
generate a comfort model for each respective occupant of the building using the occupant feedback and the number of variables associated with the building; and
assign each respective occupant to a space in the building based on the comfort model generated for each respective occupant and the number of variables associated with the building.

2. The controller of claim 1, wherein:
the number of variables associated with the building include a number of internal variables of the building; and
the assigned spaces are based on the internal variables of the building.

3. The controller of claim 1, wherein each respective occupant is assigned to a space based on heating, ventilation, and air-conditioning (HVAC) costs of conditioning the spaces to a specified level of comfort.

4. The controller of claim 1, wherein the processor is configured to execute the instructions to generate a comfort graph, wherein:
the comfort graph includes data points for each of the number of occupants of the building, wherein each data point is based on an ideal comfort level and an environmental sensitivity of each respective occupant;
the ideal comfort level is based on the number of variables associated with the building where each respective occupant feels comfortable; and
the environmental sensitivity for each respective occupant is based on a slope of the comfort model for each respective occupant.

5. The controller of claim 1, wherein the processor is configured to execute the instructions to generate the comfort model for each respective occupant by plotting the occupant feedback for each respective occupant and the number of variables associated with the building.

6. The controller of claim 1, wherein the occupant feedback indicates:
a temperature of the building is too hot;
the temperature of the building is comfortable; or the temperature of the building is too cold.

7. The controller of claim 1, wherein the occupant feedback is received from a number of mobile devices corresponding to each respective occupant of the building.

8. The controller of claim 1, wherein the processor is configured to execute the instructions to weight the occupant feedback based on a role of each respective occupant.

9. The controller of claim 1, wherein the processor is configured to execute the instructions to aggregate the comfort models in response to a meeting request.

10. The controller of claim 9, wherein the processor is configured to execute the instructions to assign each respective occupant to a space in the building based on the aggregated comfort model in response to the meeting request.

11. A computer implemented method for assigning spaces in a building, comprising:
receiving, by a controller, occupant feedback for a number of occupants of a building;
receiving, by the controller, a number of variables associated with the building;
generating, by the controller, a comfort model for each respective occupant of the building using the occupant feedback and the number of variables associated with the building;
receiving, by the controller, a meeting request; and
assigning, by the controller, a space in the building in response to the meeting request using the comfort models and the number of variables associated with the building.

12. The method of claim 11, wherein the meeting request includes a list of each respective attendee of a meeting associated with the meeting request.

13. The method of claim 12, wherein the method includes assigning the space in the building in response to the meeting request using the comfort models corresponding to each respective attendee of the meeting.

14. The method of claim 11, wherein the method includes assigning the space in the building in response to the meeting request based on heating, ventilation, and air-conditioning (HVAC) costs associated with comfort models corresponding to each respective attendee of a meeting associated with the meeting request.

15. The method of claim 11, wherein the meeting request includes a time of day for a meeting associated with the meeting request, and wherein the method includes assigning the space in the building in response to the meeting request based on the time of day for the meeting.

16. The method of claim 11, wherein the method includes assigning the space in the building in response to the meeting request based on an occupant capacity of the space in the building.

17. A system for assigning spaces in a building, comprising:
a number of mobile devices, wherein each respective mobile device corresponds to a different occupant of a building; and
a controller, configured to:
receive, from the number of mobile devices, occupant feedback for a number of occupants of a number of spaces of a building;
assign a weight to the occupant feedback of each occupant;
receive, from a number of sensors, a number of variables associated with the number of spaces;
generate a comfort model for each respective occupant of the building using the occupant feedback and the number of variables associated with the number of spaces;
assign each respective occupant to a different space in the building based on the comfort model for each occupant and the number of variables associated with the number of spaces;
receive, from a mobile device of the number of mobile devices, a meeting request; and
assign a space in the building in response to the meeting request using comfort models associated with each respective attendee of a meeting associated with the meeting request and the number of variables associated with the building.

18. The system of claim 17, wherein the controller is further configured to generate, in response to receiving the meeting request, a list of candidate spaces from a total number of spaces of the building based on comfort models associated with each respective attendee of the meeting and the number of variables associated with the building.

19. The system of claim 18, wherein the assigned space is selected from the list of spaces based on heating, ventilation, and air-conditioning (HVAC) costs associated with comfort models corresponding to each attendee of the meeting.

20. The system of claim 18, wherein the assigned space is selected from the list of candidate spaces based on a time of day of the meeting.
